(19) United States
(12) Patent Application Publication
(10) Pub. No.: US 2008/0169649 A1
(43) Pub. Date: Jul. 17, 2008

(54) Flange coupling of two pipes, in particular the pipes of an exhaust system of a motor vehicle internal combustion engine

(76) Inventors: Lothar Bruckner, Leonberg (DE); Peter Buchhagen, Welzheim (DE); Hermann Strobel, Alfdorf-Hintersteinenberg (DE)

Correspondence Address: COLLARD & ROE, P.C., 1077 NORTHERN BOULEVARD, ROSLYN, NY, 11576, US

(21) Appl. No.: 10/502,989

(22) PCT Filed: Jan. 30, 2003
(86) PCT No.: PCT/DE03/00247

§ 371 Date: Jul. 29, 2004

(30) Foreign Application Priority Data
Feb. 2, 2002 (DE) 10204261.6

(51) Int. Cl. F16L 17/00; F01N 7/00

(52) U.S. Cl. 285/365; 60/322

(57) ABSTRACT

The invention relates to a flange coupling of two pipes, in particular the pipes of an exhaust system of a motor vehicle internal combustion engine. The coupling is characterized in that: each of the flanges is formed onto the corresponding pipe by the shaping of one of the pipe regions that form the respective flanges; a first of the two flanges is configured with a first connection pipe section, which engages radially in the interior of the second flange; a sealing ring is clamped between the flanges; the flanges are axially fixed by a clamping deice. The coupling is designed to be produced in an efficient manner, easy to mount and configured so that it functions reliably.

This invention relates a flange coupling of two pipes, in particular the pipes of an exhaust system of an internal combustion engine in a motor vehicle according to the preamble of Patent Claim 1.

Such a flange coupling is known from German Patent 44 44 550 A1, for example.

This invention is concerned with the problem of designing a generic flange coupling, so that it can be manufactured as economically as possible and can be installed as easily as possible while at the same time functioning satisfactorily technically.

This problem is solved by an embodiment according to the characterizing features of Claim 1.

Advantageous embodiments are the object of the subclaims.

Particularly expedient exemplary embodiments are depicted in the drawings, which show:

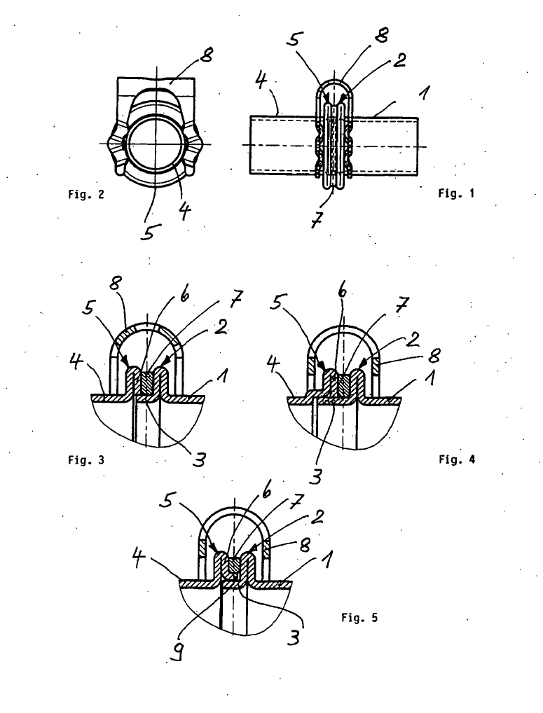

FIG. 1 a view of a pipe-flange coupling,

FIG. 2 a side view of the pipe-flange coupling according to FIG. 1,

FIG. 3 a detail of the pipe-flange coupling in FIG. 1,

FIGS. 4, 5 alternative pipe-flange couplings, each shown in a side view like that in FIG. 3.

In the embodiments according to FIGS. 1-3, a first flange 2 is integrally molded onto a first pipe 1 as a ring fold which protrudes radially outward with a first connecting pipe section 3 running from this ring fold so that it ends freely and is centered with respect to the axis of this flange 2.

A second flange 5 is also integrally molded onto a second pipe 4 in the form of a ring fold that protrudes outward as the counterpart to the first flange 2. On the inside radially, the flange section 6 of the second flange 5 facing the first flange 2 is set back radially toward the outside with respect to the inside diameter of the second pipe 4. Due to this radial setback, the first connecting pipe section 3 can become engaged on the inside radially in the flange section 6 of the second flange, thereby achieving a centering of the two pipes 1 and 4.

To achieve a tight flange coupling, a sealing ring 7 which sits radially on the outside of the first connecting pipe section 3 is provided between the two flanges 2 and 5.

A spring clamp 8, which is placed on the two pipes and acts axially on the flanges 2 and 5 with axial tension, ensures a tight closure of the flange coupling.

In the embodiment according to FIG. 4, the second flange 5 is widened from the inside radially in its diameter on the whole, including a short adjacent pipe region, so that the first connecting pipe section 3, which is dimensioned accordingly with respect to its axial length, can engage in this widened section to achieve a mutual centering effect.

In the embodiment according to FIG. 5, a second connecting pipe section 9 which ends axially freely is integrally molded on the second flange 5 and is designed on the inside radially, so that its inside diameter is the same as that of the two other embodiments already described. The mutual centering of the two flanges 2, 5 is accomplished here by insertion of the first connecting pipe section 3 into the second connecting pipe section 9. The sealing ring 7 is between the two flanges 2, 5 and rests on the outside circumference of the second connecting pipe section 9.

1-4. (canceled)

5. A flange coupling of two pipes (1, 4), in particular the pipes of an exhaust system of an internal combustion engine of a motor vehicle, in which
one flange (2, 5) is integrally molded onto the respective pipes (1, 2) by forming a pipe region which forms the respective flange (2, 5),
a first flange (2) of the two flanges is designed as a ring fold which protrudes outward, with a first connecting pipe section (3) which ends freely and is centered with respect to the common axis of the flanges (2, 5), said section engaging radially on the inside in the second flange (5),
a sealing ring (7) is clamped between the flanges (2, 5),
the flanges (2, 5) are clamped axially by a clamping device (8),
the first connecting pipe section (3) is centered radially in the area of the second flange (5) and/or inside the second pipe (4), which is adjacent to thereto,
the sealing ring (7) is situated outside of the pipes (1, 4) and contacts only the first connecting pipe section (3) of the first pipe (1) or a second connecting pipe section (9), which ends freely axially, of the second pipe (4) in the case of only axial clamping between the flanges (2) and (5) toward the inside radially,
wherein
the second flange (5) is designed as an integrally molded ring fold which protrudes radially outward, its flange section (6) which is adjacent to the first flange (2) having a recess which is directed radially outward with respect to the inside diameter of the pipe (4) belonging to the second flange (5) for centered accommodation of the first connecting pipe section (3) of the first flange (2).

6. The flange coupling according to claim 5, wherein
the second flange (5) is designed as an integrally molded ring fold which protrudes outward and has a diameter that is enlarged on the whole in comparison with the adjacent inside diameter of the pipe to accommodate the connecting pipe section (3) of the first pipe (1).

7. The flange coupling according to claim 5, wherein
the region of the second flange (5), which is recessed with respect to the outside radially, is designed as a second connecting pipe section (9) which ends freely axially.
